(19) United States
(12) Patent Application Publication
(10) Pub. No.: US 2006/0174207 A1
(43) Pub. Date: Aug. 3, 2006

(54) Systems and methods for implementing a user interface for multiple simultaneous instant messaging, conference and chat room sessions

(75) Inventor: Sachin G. Deshpande, Vancouver, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc.

(21) Appl. No.: 11/047,144

(22) Filed: Jan. 31, 2005

(51) Int. Cl. G06F 17/00; G06F 3/00; G06F 9/00

(52) U.S. Cl. 715/758

(57) ABSTRACT

An exemplary method involves displaying a single user interface window having one or more of a list area, a messages area, and a message creation area. The method also involves displaying in the list area information about at least one one-to-one instant messaging session and/or at least one conference instant messaging session and/or at least one chat room session in which a user is participating. The method also involves displaying in the messages area messages corresponding to the at least one one-to-one instant messaging session and/or the at least one conference instant messaging session and/or the at least one chat room session. The method also involves displaying in the message creation area a new message to be sent from the user to one or more other participants of the at least one one-to-one instant messaging session and/or the at least one conference instant messaging session and/or the at least one chat room session.

### TECHNICAL FIELD

The present invention relates generally to computers and computer-related technology. More specifically, the present invention relates to systems and methods for implementing a user interface for multiple simultaneous instant messaging, conference and chat room sessions.

### BACKGROUND

Instant messaging refers to the process of exchanging text messages between two or more people. Instant messaging differs from e-mail in that conversations happen in real time. The parties in the conversation typically see each line of text right after it is typed (line-by-line). Also known as a “chatting,” instant messaging has become very popular for both business and personal use.

An instant messaging (hereinafter, “IM”) client may be used to send instant messages to and receive instant messages from other users. Many different IM clients are known to those skilled in the art. Examples of IM clients include Yahoo! Messenger, MSN Messenger, America Online's Instant Messenger (AIM), and a variety of others including those based on the Jabber Open XML Protocol.

Many IM clients support chatting between two users participating in a one-to-one fashion. This type of interaction will be referred to herein as a one-to-one IM session. Many IM clients also support chatting between more than two users simultaneously. This type of interaction will be referred to herein as a conference IM session.

A chat room is a web site or an online service where people can communicate with each other in real time. Like instant messaging, conversations in a chat room happen in real time. A user who is logged in to a chat room may enter messages which are immediately displayed to other users who are also logged in to the chat room. Chat rooms may be used for a variety of purposes, such as keeping in touch with friends and relatives, coordinating meetings with business colleagues, and so forth.

A chat client may be used to participate in chat room conversations. There are many dedicated chat clients available. Some chat systems are run from a web server. A web browser can act as a chat client. Chat client software may also come as part of a package of communication and collaboration tools, such as Microsoft NetMeeting®. A conversation between two or more users in a chat room will be referred to herein as a chat room session.

There are several drawbacks associated with known user interfaces for one-to-one IM sessions, conference IM sessions, and chat room sessions. These drawbacks are especially noticeable when there are multiple simultaneous one-to-one IM sessions, conference IM sessions, and/or chat room sessions taking place. Accordingly, benefits may be realized by improved systems and methods for implementing a user interface for one-to-one IM sessions, conference IM sessions, and chat room sessions.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a functional block diagram which illustrates an exemplary system in which some embodiments may be practiced;

FIG. 2 illustrates an embodiment of a user interface for multiple simultaneous one-to-one IM sessions, conference IM sessions and/or chat room sessions;

FIG. 3 illustrates another embodiment of a user interface for multiple simultaneous one-to-one IM sessions, conference™ sessions and/or chat room sessions;

FIG. 4 illustrates another embodiment of a user interface for multiple simultaneous one-to-one IM sessions, conference IM sessions and/or chat room sessions;

FIG. 5 illustrates another embodiment of a user interface for multiple simultaneous one-to-one IM sessions, conference IM sessions and/or chat room sessions;

FIG. 6 illustrates another embodiment of a user interface for multiple simultaneous one-to-one IM sessions, conference IM sessions and/or chat room sessions;

FIG. 7 illustrates another embodiment of a user interface for multiple simultaneous one-to-one IM sessions, conference IM sessions and/or chat room sessions;

FIG. 8 is a flow diagram which illustrates an exemplary method for implementing a user interface for multiple simultaneous one-to-one IM sessions, conference IM sessions and chat room sessions; and

FIG. 9 is a block diagram illustrating the major hardware components typically utilized in a computing device.

### DETAILED DESCRIPTION

A method for implementing a user interface for multiple simultaneous one-to-one instant messaging sessions, conference instant messaging sessions and chat room sessions is disclosed. The method involves displaying a single user interface window having one or more of a list area, a messages area, and a message creation area. The method also involves displaying in the list area information about at least one one-to-one instant messaging session and/or at least one conference instant messaging session and/or at least one chat room session in which a user is participating. The method also involves displaying in the messages area messages corresponding to the at least one one-to-one instant messaging session and/or the at least one conference instant messaging session and/or the at least one chat room session. The method also involves displaying in the message creation area a new message to be sent from the user to one or more other participants of the at least one one-to-one instant messaging session and/or the at least one conference instant messaging session and/or the at least one chat room session.

In some embodiments, identifying information about the other participants of the at least one one-to-one instant messaging session and/or the at least one conference instant messaging session and/or the at least one chat room session is displayed in the list area. The identifying information may be displayed in different regions of the list area corresponding to different one-to-one instant messaging sessions, conference instant messaging sessions, and chat room sessions. Alternatively, the identifying information may be displayed in a common list.

A session identifier may be displayed with each message that is displayed in the messages area. The session identifier may comprise a text characteristic.

The method may also involve receiving the new message to be sent. In some embodiments receiving the new message to be sent involves receiving text entered by the user in the message creation area. Alternatively, in some embodiments receiving the new message to be sent involves displaying a list of pre-created messages, and receiving the user's selection of one of the pre-created messages.

The method may also involve receiving the user's selection of one or more recipients of the new message to be sent. The user's selection of the one or more recipients may be received via the list area. Alternatively, receiving the user's selection of the one or more recipients may involve detecting that the user has activated at least one remote control key, and identifying which of the at least one one-to-one instant messaging session and/or the at least one conference instant messaging session and/or the at least one chat room session is associated with the at least one remote control key. Alternatively still, receiving the user's selection of the one or more recipients of the new message to be sent involves receiving text entered by the user in the message creation area.

In some embodiments, recipient information may be displayed in the message creation area. The recipient information identifies one or more recipients of the new message.

The new message may be sent to one or more intended recipients based on some action taken by the user. The action may be pressing a button on a remote control device or an input device.

In some embodiments, for each message that is displayed in the messages area, identifying information about a sender of the message may be displayed. Also, in some embodiments the messages area may be partitioned into different regions corresponding to different one-to-one instant messaging sessions, conference instant messaging sessions, and chat room sessions. Also, in some embodiments an indication of at least one input device control that is associated with each of the at least one one-to-one instant messaging session and/or the at least one conference instant messaging session and/or the at least one chat room session may be displayed. Also, in some embodiments the computing device may be a television.

A computer-readable medium for implementing the above-described method for implementing a user interface for multiple simultaneous one-to-one instant messaging sessions, conference instant messaging sessions and chat room sessions is also disclosed. The computer-readable medium comprises executable instructions for implementing the above-described method.

In addition, a computing device configured to implement the above-described method for implementing a user interface for multiple simultaneous one-to-one instant messaging sessions, conference instant messaging sessions and chat room sessions is also disclosed. The computing device includes a processor and memory in electronic communication with the processor. Instructions are stored in the memory. The instructions are executable to implement the above-described method.

Various embodiments of the invention are now described with reference to the Figures, where like reference numbers indicate identical or functionally similar elements. It will be readily understood that the embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Those skilled in the art will appreciate that many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, those skilled in the art will recognize that such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

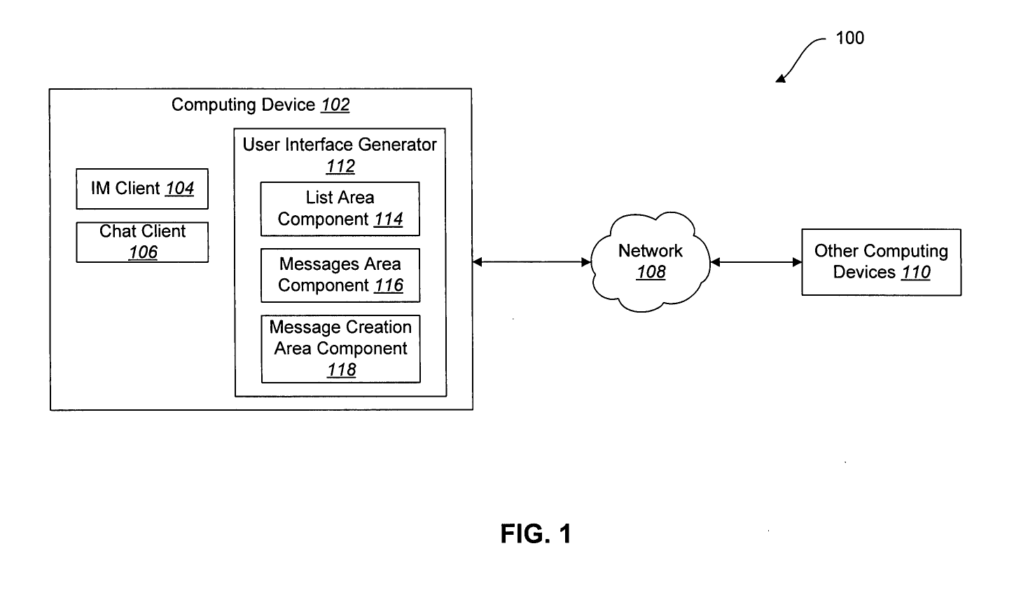

FIG. 1 is a functional block diagram which illustrates an exemplary system 100 in which some embodiments may be practiced. The system 100 includes a computing device 102. Examples of computing devices 102 include televisions, personal computers, personal digital assistants (PDAs), television set-top boxes, cellular telephones, intelligent appliances, and so forth.

The computing device 102 includes an IM client 104 and a chat client 106. The computing device 102 is in electronic communication with other computing devices 110 via one or more computer networks 108. The other computing devices 110 may also include IM clients (not shown) and/or chat clients (not shown). In some cases the IM client 104 and chat client 106 functionality may be supported by a single client module.

As indicated above, two users exchanging instant messages in a one-to-one fashion will be referred to herein as a one-to-one IM session. The exchange of instant messages between more than two users will be referred to herein as a conference IM session. The term “IM session,” as used herein, refers to either a one-to-one IM session or a conference IM session. A conversation between two or more users in a chat room will be referred to herein as a chat room session.

The IM client 104 may be used to set up and participate in one-to-one IM sessions and/or conference IM sessions with users of the other computing devices 110. The chat client 106 may be used to set up and participate in chat room sessions with users of the other computing devices 110.

Known IM clients display a separate window for each one-to-one IM session and conference IM session in which the user is participating. Similarly, known chat clients display a separate window for each chat room session in which the user is participating. Thus, with known IM and chat clients, the user needs to change focus between different windows when he or she is participating in multiple simultaneous one-to-one IM sessions, conference IM sessions, and/or chat room sessions.

There are several drawbacks with this design, particularly for a television user who is interacting passively with an IM/chat client on a television. On a television screen typically only one window may be visible at a time, because the distance between the user and the television is typically great enough to warrant a large text font size, which in turn requires a larger screen area for each IM and chat room session window. Thus, the user may be required to repeatedly switch between different windows, requiring repeated clicking of remote control/input device buttons. This may be inconvenient and frustrating for the user, and may make it difficult for the user to actively participate in multiple simultaneous IM/chat room sessions. Even in a personal computer environment such a design may be inconvenient, particularly if the user's monitor is not large enough to display multiple windows simultaneously.

To address at least some of these issues, the computing device 102 also includes a user interface generator 112. The user interface generator 112 is configured to generate an improved user interface for IM/chat room sessions that the user participates in. The user interface is particularly convenient for multiple simultaneous one-to-one IM sessions, conference IM sessions and/or chat room sessions. Advantageously, the user interface displays messages corresponding to different IM/chat room sessions in a single window. This window also includes controls which allow the user to send messages to participants of the different IM/chat room sessions. A list of the other participants in the current IM/chat room sessions may also be displayed. Thus, the user interface allows the user to participate more easily in multiple simultaneous conversations corresponding to different IM/chat room sessions, without the need to change focus between different windows.

The embodiment of the user interface generator 112 shown in FIG. 1 includes a list area component 114. The list area component 114 generates a list area within the user interface. The list area displays information about the current one-to-one IM sessions, conference IM sessions and chat room sessions in which the user is participating. This information may identify the other participants of the current IM/chat room sessions. For example, if the user has an active chat room session, the list area may display the usernames of all of the individuals who have logged in to the chat room.

The user interface generator 112 also includes a messages area component 116. The messages area component 116 generates a messages area within the user interface. The messages area displays messages corresponding to the current IM/chat room sessions, i.e., messages that have been received from or sent to the other participants of the current IM/chat room sessions. The messages area may be arranged so that the user may easily identify which IM/chat room session a particular message corresponds to.

The user interface generator 112 also includes a message creation area component 118. The message creation area component 118 generates a message creation area within the user interface. From time to time, the user may create new messages to send to one or more of the other participants of the current IM/chat room sessions. If the user is creating a new message to send, this message may be displayed in the message creation area. In addition, the message creation area may include controls which allow the user to more easily create the new message, and also to select which of the other IM/chat room session participants will receive the message.

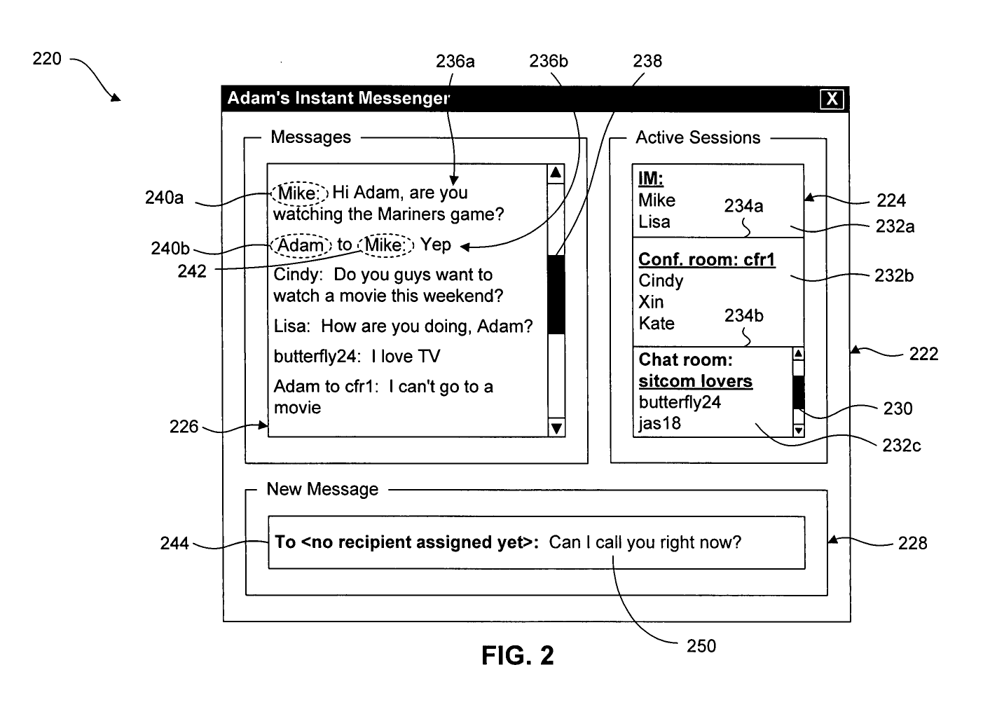

FIG. 2 illustrates an embodiment of a user interface 220 for multiple simultaneous one-to-one IM sessions, conference IM sessions and/or chat room sessions. The user interface 220 includes a single user interface window 222. A list area 224, a messages area 226, and a message creation area 228 are displayed within the user interface window 222.

The list area 224 displays information about the current one-to-one IM sessions, conference IM sessions and chat room sessions in which the user is participating. In the illustrated embodiment, this information includes the usernames of the other participants of the IM/chat room sessions in which the user is involved. The user is participating in two one-to-one IM sessions, one with Mike and one with Lisa. The user is also participating in a single conference IM session. The name of the conference session is cfr1, and it includes three participants: Cindy, Xin and Kate. The user is also participating in a single chat room session. The name of the chat room session is sitcom lovers. Two of the participants in the chat room session are shown in the list area 224, butterfly24 and jas18. A scroll bar 230 is displayed alongside the chat room session participants. The user may move the scroll bar 230 in order to see additional participants in the chat room session.

The list area 224 is partitioned into different regions 232 corresponding to different one-to-one IM sessions, conference IM sessions, and chat room sessions. In the illustrated embodiment, the list area 224 is partitioned so that there is a separate region 232 in the list area 224 for each type of IM/chat room session that the user is participating in. Thus, the usernames of the other participants in all of the one-to-one IM sessions are shown in a first region 232a of the list area 224, the usernames of the other participants in all of the conference IM sessions are shown in a second region 232b of the list area 224, and the usernames of the other participants in all of the chat room sessions are shown in a third region 232c of the list area 224.

Separators 234 are displayed between the different regions 232 of the list area, in order to visually differentiate participants in the different types of IM/chat room sessions from one another. A first separator 234a is displayed between the first region 232a of the list area 224 comprising the one-to-one IM session participants and the second region 232b of the list area 224 comprising the conference IM session participants. A second separator 234b is displayed between the second region 232b of the list area 224 comprising the conference IM session participants and the third region 232c of the list area 224 comprising the chat room session participants.

The messages area 226 displays messages 236 corresponding to the current IM/chat room sessions, i.e., messages 236 that have been received from or sent to the other participants of the current IM/chat room sessions. As shown, messages 236 from different IM/chat room sessions may be displayed together in a common list. The messages 236 may be displayed in the order in which they were received. A scroll bar 238 is provided to allow the user to scroll through the list of messages 236.

For each message 236 that is displayed in the messages area 226, information that identifies the sender of the message may be displayed. In the illustrated embodiment, this information is the sender's username 240. The sender's username 240 is displayed at the beginning of the message 236. For example, in the first message 236a that is displayed, “Mike” is the sender's username 240a, and “Hi Adam, are you watching the Mariners game?” is the text of the message 236a.

For messages 236 that the user has sent, information that identifies the recipient of the message may also be displayed. For example, in the second message 236b that is displayed, “Adam” is the username 240b of the user who has sent the message, “Mike” is the recipient's usemrname 242, and “Yep” is the text of the message 236b.

If the user is creating a new message 250 to send, this new message 250 may be displayed in the message creation area 228. The new message 250 may be entered by the user in a variety of ways. In the illustrated embodiment, the user has entered the new message 250 by typing text in a text box 244 within the message creation area 228.

Recipient information may be displayed in the message creation area 228 to identify the participant(s) to whom the message is sent. However, if the user has not yet selected the recipient(s) for the message, a message to that effect may be displayed in the message creation area 228. In the illustrated embodiment, the user has not selected a recipient for the message. Thus, the message “no recipient assigned yet” is displayed in the message creation area 228.

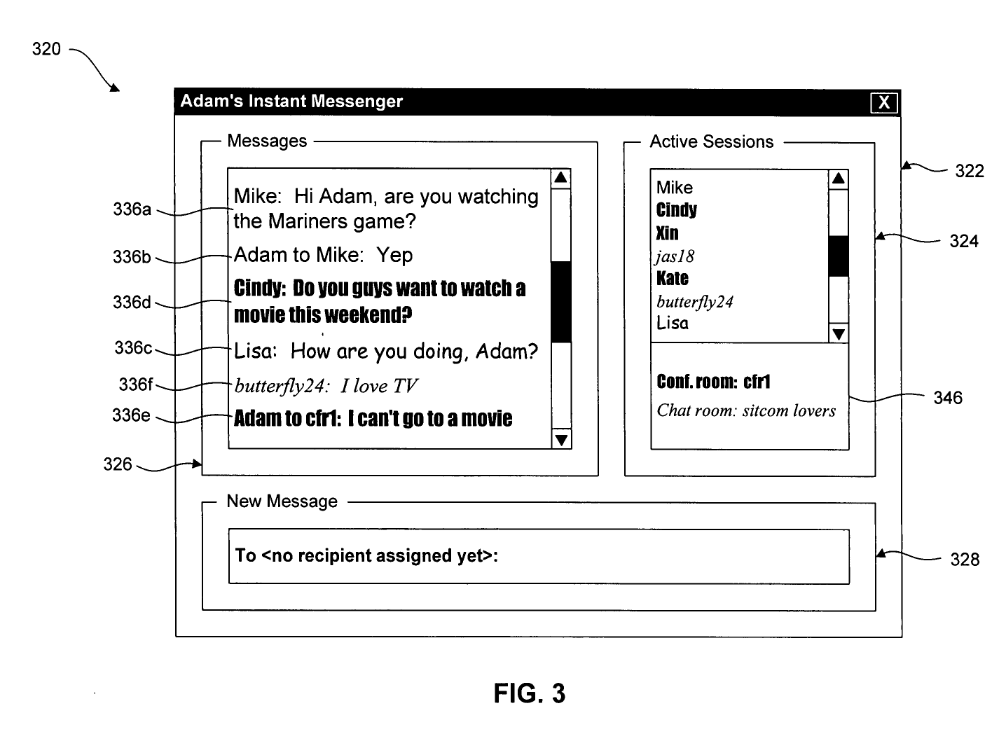

FIG. 3 illustrates another embodiment of a user interface 320 for multiple simultaneous one-to-one IM sessions, conference IM sessions and/or chat room sessions. As before, the user interface 320 includes a single user interface window 322. A list area 324, a messages area 326, and a message creation area 328 are displayed within the user interface window 322.

As before, the list area 324 displays the usernames of the other participants of the IM/chat room sessions that the user is involved in. However, in the illustrated embodiment, the usernames are displayed in a common list. In other words, the usernames are displayed in a single region of the list area 324 without separators.

As before, the messages area 326 displays messages 336 corresponding to the current IM/chat room sessions. These messages 336 are displayed together in a common list. The messages area 326 is arranged so that the user may easily identify which IM/chat room session a particular message corresponds to. In the illustrated embodiment, this is accomplished by displaying a session identifier with each message 336 in the messages area 326. The session identifier displayed with a particular message identifies the IM/chat room session that the message 336 corresponds to.

In the illustrated embodiment, the session identifier is a text characteristic. Messages 336 corresponding to different IM/chat room sessions are shown using different fonts. More specifically, the messages 336a, 336b corresponding to the one-to-one IM session with Mike are shown in a different font than the message 336c corresponding to the one-to-one IM session with Lisa, which is shown in a different font than the messages 336d, 336e corresponding to the conference IM session with cfr1, and so on.

There may be many participants in conference IM sessions and chat room sessions. Thus, when the user looks at a message 336 from a participant of a conference IM session or a chat room session, it may not be readily apparent which IM/chat room session the message 336 corresponds to. For example, consider the message 336d from Cindy shown in the messages area 326 in FIG. 3. Even though the username “Cindy” is displayed in the message, the user may not immediately know whether Cindy is participating in the conference IM session “cfr1” or the chat room session “sitcom lovers.”

To address this issue, a session identifier key 346 may be shown. The names of the conference IM sessions and chat room sessions are shown in the session identifier key 346 in the same font that is used to display the corresponding messages in the messages area 326. For example, the name of the conference IM session “cfr1” is shown in the session identifier key 346 in the same font that is used to display the corresponding messages 336d, 336e in the messages area 326. Similarly, the name of the chat room session “sitcom lovers” is shown in the session identifier key 346 in the same font that is used to display the corresponding message 336f in the messages area 326. In this way, if the user is unsure which IM/chat room session a particular message 336 corresponds to, the user can find out by quickly glancing at the session identifier key 346.

In the illustrated embodiment, the session identifier key 346 is shown in the list area 324. However, in alternative embodiments, the session identifier key 346 may be shown in the messages area 326 or elsewhere in the user interface window 322. Alternatively session identifier key information may be displayed along with each message 336 in the message area 326.

In alternative embodiments, session identifiers may comprise text characteristics other than fonts. For example, messages 336 corresponding to different IM/chat room sessions may be displayed using different text sizes, colors, etc. In other embodiments, the session identifier may be something other than a text characteristic. For example, each IM/chat room session may be associated with a unique icon, and the icon corresponding to the appropriate IM/chat room session may be displayed along with each message 336.

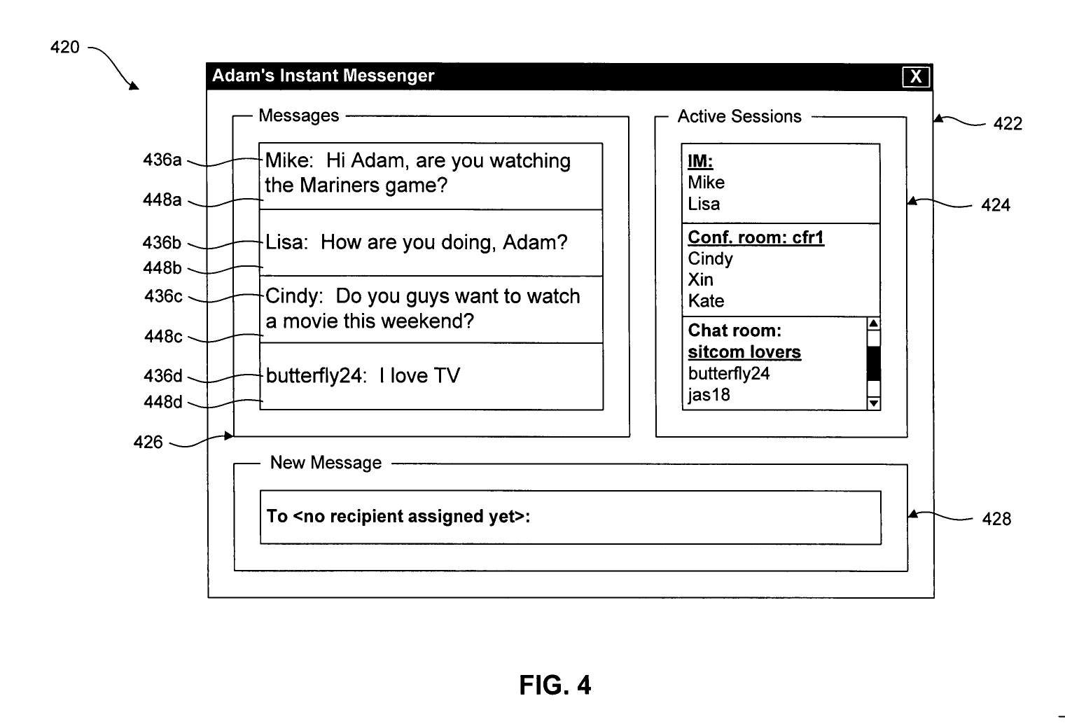

FIG. 4 illustrates another embodiment of a user interface 420 for multiple simultaneous one-to-one IM sessions, conference IM sessions and/or chat room sessions. As before, the user interface 420 includes a single user interface window 422. A list area 424, a messages area 426, and a message creation area 428 are displayed within the user interface window 422.

As before, the messages area 426 displays messages 436 corresponding to the current IM/chat room sessions. The messages area 426 is arranged so that the user may easily identify which IM/chat room session a particular message corresponds to. In the illustrated embodiment, this is accomplished by partitioning the messages area 426 into different regions 448 corresponding to different one-to-one IM sessions, conference IM sessions, and chat room sessions.

In the illustrated embodiment, the messages area 426 is partitioned so that there is a separate region 448 in the messages area 426 for each IM/chat room session that the user is participating in. Thus, messages 436a corresponding to the one-to-one IM session with Mike are displayed in a first region 448a of the messages area 426. Messages 436b corresponding to the one-to-one IM session with Lisa are displayed in a second region 448b of the messages area 426. Messages 436c corresponding to the conference IM session named “cfr1” are displayed in a third region 448c of the messages area 426. Messages 436d corresponding to the chat room session named “sitcom lovers” are displayed in a fourth region 448d of the messages area 426.

In alternative embodiments, the messages area 426 may be partitioned differently. For example, the messages area 426 may be partitioned so that the messages 436 corresponding to the same type of IM/chat room session are shown in the same region of the messages area 426. For example, the messages area 426 may be partitioned so that messages from all of the one-to-one IM sessions are shown in the same region of the messages area 426, messages from all of the conference IM sessions are shown in the same region of the messages area 426, and messages from all of the chat room sessions are shown in the same region of the messages area 426.

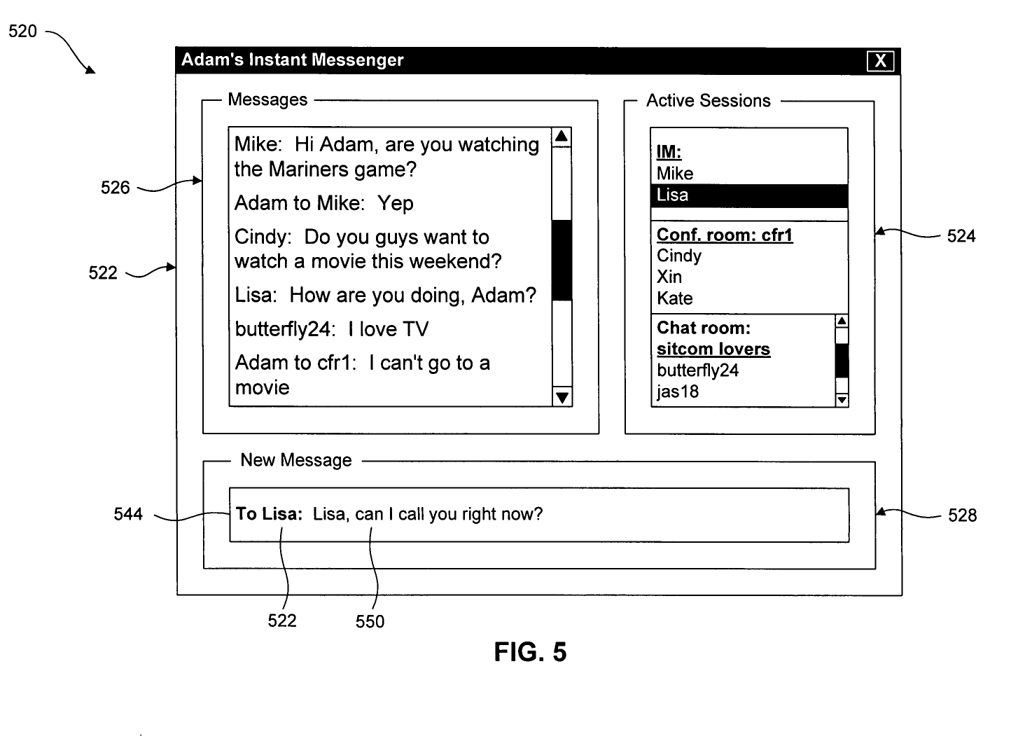

FIG. 5 illustrates another embodiment of a user interface 520 for multiple simultaneous one-to-one IM sessions, conference IM sessions and/or chat room sessions. As before, the user interface 520 includes a single user interface window 522. A list area 524, a messages area 526, and a message creation area 528 are displayed within the user interface window 522.

As indicated above, the user may create a new message 550 to be sent to one or more other participants of a current one-to-one IM session, conference IM session, and/or chat room session. As shown, the new message 550 may be displayed in the message creation area 528.

The user may select the recipient(s) of the new message 550 in a variety of ways. For example, the user may select the recipient(s) of the new message via the list area 524. In the illustrated embodiment, an input device has been used to highlight “Lisa” in the list area 524. A control on the input device (e.g., a “Select” button) may then be used to indicate the user's selection of Lisa as the recipient of the new message 550. Different types of input devices may be used, depending on the type of environment in which embodiments disclosed herein are practiced. For example, in a television environment, the input device may be a remote control device. In a personal computing environment, the input device may be a mouse, keyboard, etc. In alternative embodiments, the user may select the recipient(s) of the new message by simply entering text into a text box 544 within the message creation area 528.

Once the user has selected one or more recipients for the new message 550, recipient information is also displayed in the message creation area 528 along with the new message 550. The recipient information identifies the recipient(s) of the new message 550. In the illustrated embodiment, the recipient information is the username 552 of the recipient of the new message. Because the user has selected Lisa to receive the new message, the username “Lisa” 552 is displayed in the message creation area 528.

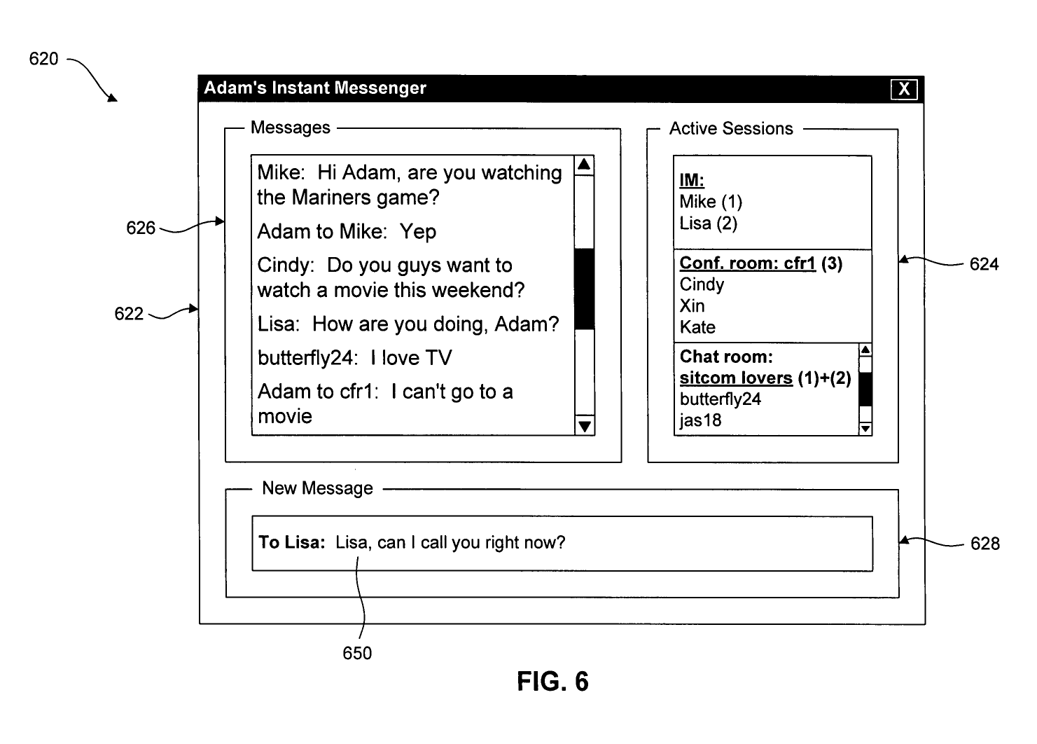

FIG. 6 illustrates another embodiment of a user interface 620 for multiple simultaneous one-to-one μM sessions, conference IM sessions and/or chat room sessions. As before, the user interface 620 includes a single user interface window 622. A list area 624, a messages area 626, and a message creation area 628 are displayed within the user interface window 622.

As indicated above, from time to time the user may create a new message 650 to be sent to one or more of the other participants of a one-to-one IM session, a conference IM session, and/or a chat room session. To enable the user to easily select one or more recipients of the new message 650, one or more input device controls (e.g., buttons on a remote control device, keys on a keyboard, etc.) may be associated with each one-to-one IM session, conference IM session, and chat room session. When the user activates a control that is associated with a particular IM/chat room session, the participant(s) of that IM/chat room session are selected as the recipient(s) of the new message 650. More specifically, the user interface generator 112 detects which control (or combination of controls) the user has activated. The user interface generator 112 then identifies which IM/chat room session is associated with the activated control(s).

In the illustrated embodiment, button number “1” on an input device is associated with Mike. Thus, when the user presses button number “1,” this has the effect of selecting Mike as the recipient of the new message 650. Similarly, button number “2” on the input device is associated with Lisa. Therefore, pressing button number “2” has the effect of selecting Lisa as the recipient of the new message 650. Button number “3” on the input device is associated with the conference IM session named cfr1. Therefore, pressing button number “3” has the effect of selecting the other participants of the conference IM session named cfr1 as the recipients of the new message 650. The combination of buttons “1” and “2” on the input device is associated with the chat room session named sitcom lovers. Therefore, pressing buttons “1” and “2” substantially simultaneously has the effect of selecting the other participants of the chat room session named sitcom lovers as the recipients of the new message 650.

An indication of the input device control (or combination of controls) associated with an IM/chat room session is displayed in the list area 624. This enables the user to quickly see which input control(s) should be activated in order to send a message to the participant(s) of a particular IM/chat room session. In the illustrated embodiment, the number “1” is displayed alongside Mike in the list area 624, the number “2” is displayed alongside Lisa in the list area 624, the number “3” is displayed alongside the conference IM session named cfr1 in the list area 624, and the numbers “1” and “2” are displayed alongside the chat room session named sitcom lovers in the list area 624.

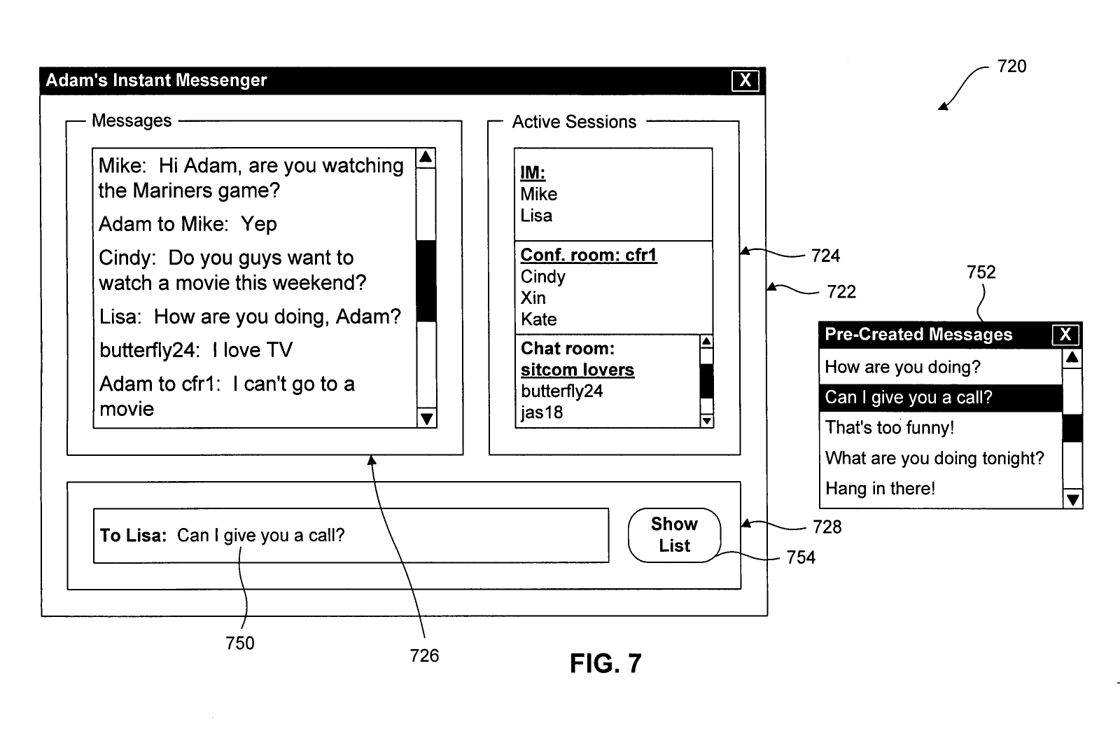

FIG. 7 illustrates another embodiment of a user interface 720 for multiple simultaneous one-to-one IM sessions, conference IM sessions and/or chat room sessions. As before, the user interface 720 includes a single user interface window 722. A list area 724, a messages area 726, and a message creation area 728 are displayed within the user interface window 722.

As indicated above, from time to time the user may create a new message 750 to be sent to one or more of the other participants of a one-to-one IM session, a conference IM session, and/or a chat room session. In some embodiments, the user may create the new message 750 by selecting the new message 750 from a list 752 of pre-created messages.

In the illustrated embodiment, the message creation area 728 includes a “Show List” button 754. When the user activates the “Show List” button 754, a list 752 of pre-created messages is displayed. The list 752 of pre-created messages may include messages created by the IM client 104, the chat client 106, the user interface generator 112, and/or the user.

An input device may be used to select a message from the list 752 of pre-created messages. In the illustrated embodiment, an input device has been used to highlight a particular message in the list 752 of pre-created messages. A control on the input device (e.g., a “Select” button) may then be used to indicate the user's selection of the highlighted message.

Once the user has selected a message from the list 752 of pre-created messages, the text of the selected message may be displayed in the message creation area 728. The user may alter the message before it is sent to the message recipient(s). The message can be sent to the intended recipient(s) when the user takes an action to send it (for example, by pressing an input device button). In some embodiments numerical keys on an input device may be assigned to pre-created messages. In some embodiments all pre-created messages may be displayed in a separate region of the user interface displayed by the IM client.

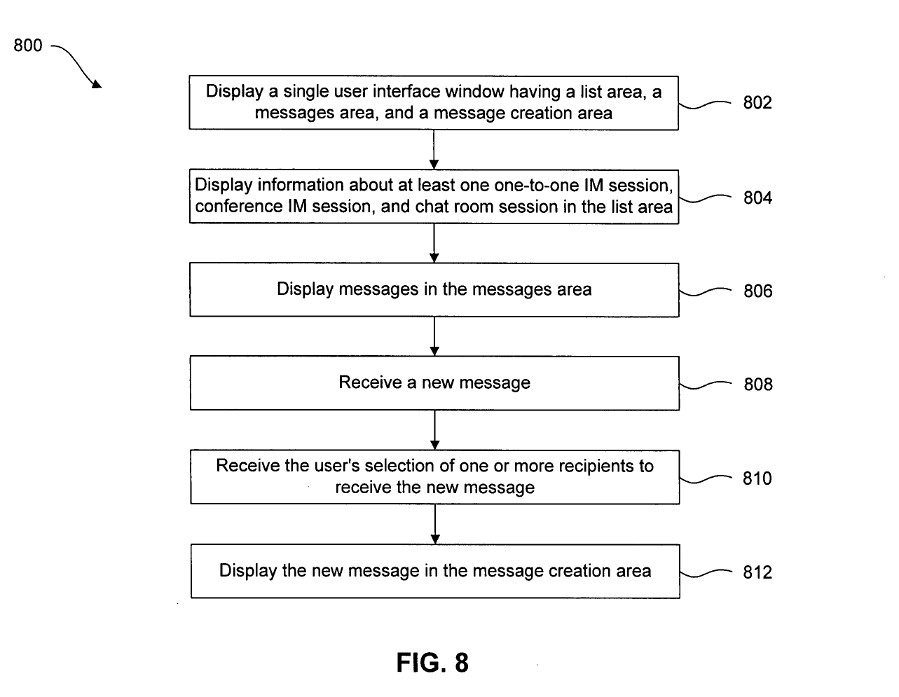

FIG. 8 is a flow diagram which illustrates an exemplary method 800 for implementing a user interface for multiple simultaneous one-to-one IM sessions, conference IM sessions and chat room sessions. The method 800 may be performed by the user interface generator 112.

A single user interface window 222 is displayed 802. The user interface window 222 includes a list area 224, a messages area 226, and a message creation area 228. In some embodiments only one or more of these areas may be shown, and the user may be able to select which of the list area 224, the messages area 226 and the message creation area 228 are displayed. For example, the user may choose to display the list area 224 and the messages area 226, but not the message creation area 228. In some embodiments, the user may select which of the list area 224, the messages area 226 and the message creation area 228 are displayed via configuration of the IM client.

Information about at least one one-to-one IM session, conference IM session, and chat room session is displayed 804 in the list area 224. In some embodiments, this information may include the usernames of the other participants of the IM/chat room sessions in which the user is currently involved.

Messages 236 corresponding to the current one-to-one IM sessions, conference IM sessions, and chat room sessions are displayed 806 in the messages area 226. Messages 236 from different IM/chat room sessions may be displayed together in a common list. Alternatively, the messages area 226 may be partitioned into different regions corresponding to different IM/chat room sessions.

From time to time, the user may create a new message 250 to send to one or more participants in the current IM/chat room sessions. When this occurs, the user interface generator 112 receives 808 the new message 250. The user may input the new message in a variety of ways. For example, the user may enter the text of the new message in the message creation area 228. As another example, the new message may be selected from a list 752 of pre-created messages.

The user's selection of one or more recipient(s) for the new message 250 is also received 810. The user may select the recipient(s) of the new message 250 in a variety of ways. For example, the user may select the recipient(s) of the new message 250 by designating one or more participants of other IM/chat room sessions that are displayed in the list area 224, by entering text into the message creation area 228, by activating an input device control that is associated with a particular IM/chat room session, and so forth.

When the new message has been received 808, it is displayed 812 in the message creation area 228. Recipient information 552, such as the username(s) of the message recipient(s), may also be displayed along with the new message 250 in the message creation area 228. The message can be sent 813 to the intended recipient(s) when the user takes an action to send it (for example, by pressing a button on an input device).

In view of the foregoing, the embodiments disclosed herein offer several advantages not available in conventional approaches. The embodiments disclosed herein relate to a user interface which displays messages corresponding to different IM/chat room sessions in a single window. This window also includes controls which allow the user to send messages to participants of the different IM/chat room sessions. A list of the other participants in the current IM/chat room sessions may also be displayed. Thus, the user interface allows a user to participate more easily in multiple simultaneous conversations corresponding to different IM/chat room sessions, without the need to change focus between different windows.

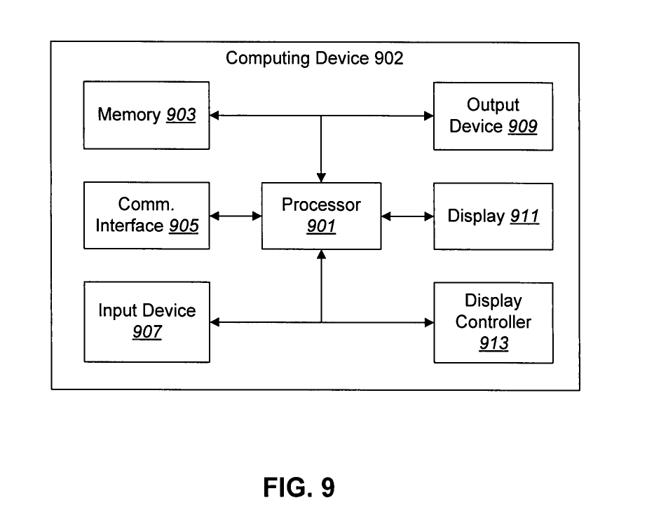

FIG. 9 is a block diagram illustrating the major hardware components typically utilized in a computing device 902. The illustrated components may be located within the same physical structure or in separate housings or structures.

The computing device 902 includes a processor 901 and memory 903. The processor 901 controls the operation of the computing device 902 and may be embodied as a microprocessor, a microcontroller, a digital signal processor (DSP) or other device known in the art. The processor 901 typically performs logical and arithmetic operations based on program instructions stored within the memory 903.

As used herein, the term memory 903 is broadly defined as any electronic component capable of storing electronic information, and may be embodied as read only memory (ROM), random access memory (RAM), magnetic disk storage media, optical storage media, flash memory devices in RAM, on-board memory included with the processor 901, EPROM memory, EEPROM memory, registers, etc. The memory 903 typically stores program instructions and other types of data. The program instructions may be executed by the processor 901 to implement some or all of the methods disclosed herein.

The computing device 902 typically also includes one or more communication interfaces 905 for communicating with other electronic devices. The communication interfaces 905 may be based on wired communication technology, wireless communication technology, or both. Examples of different types of communication interfaces 905 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 902 typically also includes one or more input devices 907 and one or more output devices 909. Examples of different kinds of input devices 907 include a keyboard, mouse, microphone, remote control device, button, joystick, trackball, touchpad, lightpen, etc. Examples of different kinds of output devices 909 include a speaker, printer, etc. One specific type of output device which is typically included in a computer system is a display device 911. Display devices 911 used with embodiments disclosed herein may utilize any suitable image projection technology, such as a cathode ray tube (CRT), liquid crystal display (LCD), light-emitting diode (LED), gas plasma, electroluminescence, or the like. A display controller 913 may also be provided, for converting data stored in the memory 903 into text, graphics, and/or moving images (as appropriate) shown on the display device 911.

Of course, FIG. 9 illustrates only one possible configuration of a computing device 902. Those skilled in the art will recognize that various other architectures and components may be utilized. In addition, various standard components are not illustrated in order to avoid obscuring aspects of the invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. In a computing device, a method for implementing a user interface for multiple simultaneous one-to-one instant messaging sessions, conference instant messaging sessions and chat room sessions, the method comprising:
displaying a single user interface window having one or more of a list area, a messages area, and a message creation area;
displaying in the list area information about at least one one-to-one instant messaging session and/or at least one conference instant messaging session and/or at least one chat room session in which a user is participating;
displaying in the messages area messages corresponding to the at least one one-to-one instant messaging session and/or the at least one conference instant messaging session and/or the at least one chat room session; and
displaying in the message creation area a new message to be sent from the user to one or more other participants of the at least one one-to-one instant messaging session and/or the at least one conference instant messaging session and/or the at least one chat room session.

2. The method of claim 1, further comprising displaying in the list area identifying information about the other participants of the at least one one-to-one instant messaging session and/or the at least one conference instant messaging session and/or the at least one chat room session.

3. The method of claim 2, wherein the identifying information is displayed in different regions of the list area corresponding to different one-to-one instant messaging sessions, conference instant messaging sessions, and chat room sessions.

4. The method of claim 2, wherein the identifying information is displayed in a common list.

5. The method of claim 1, further comprising displaying a session identifier with each message that is displayed in the messages area.

6. The method of claim 5, wherein the session identifier comprises a text characteristic.

7. The method of claim 1, further comprising partitioning the messages area into different regions corresponding to different one-to-one instant messaging sessions, conference instant messaging sessions, and chat room sessions.

8. The method of claim 1, further comprising, for each message that is displayed in the messages area, displaying identifying information about a sender of the message.

9. The method of claim 1, further comprising receiving the new message to be sent.

10. The method of claim 9, wherein receiving the new message to be sent comprises receiving text entered by the user in the message creation area.

11. The method of claim 9, wherein receiving the new message to be sent comprises:
displaying a list of pre-created messages; and
receiving the user's selection of one of the pre-created messages.

12. The method of claim 1, further comprising receiving the user's selection of one or more recipients of the new message to be sent.

13. The method of claim 12, wherein the user's selection of the one or more recipients is received via the list area.

14. The method of claim 12, wherein receiving the user's selection of the one or more recipients comprises:
detecting that the user has activated at least one remote control key; and
identifying which of the at least one one-to-one instant messaging session and/or the at least one conference instant messaging session and/or the at least one chat room session is associated with the at least one remote control key.

15. The method of claim 1, further comprising, for each of the at least one one-to-one instant messaging session and/or the at least one conference instant messaging session and/or the at least one chat room session, displaying an indication of at least one input device control that is associated therewith.

16. The method of claim 12, wherein receiving the user's selection of the one or more recipients of the new message to be sent comprises receiving text entered by the user in the message creation area.

17. The method of claim 1, further comprising displaying recipient information in the message creation area, wherein the recipient information identifies one or more recipients of the new message.

18. The method of claim 1, further comprising sending the new message to one or more intended recipients based on some action taken by the user.

19. The method of claim 18, where the action is pressing a button on a remote control device or an input device.

20. The method of claim 1, wherein the computing device is a television.

21. A computer-readable medium comprising executable instructions for implementing a method in a computing device for implementing a user interface for multiple simultaneous one-to-one instant messaging sessions, conference instant messaging sessions and chat room sessions, the method comprising:
displaying a single user interface window having one or more of a list area, a messages area, and a message creation area;
displaying in the list area information about at least one one-to-one instant messaging session and/or at least one conference instant messaging session and/or at least one chat room session in which a user is participating;
displaying in the messages area messages corresponding to the at least one one-to-one instant messaging session and/or the at least one conference instant messaging session and/or the at least one chat room session; and
displaying in the message creation area a new message to be sent from the user to one or more other participants of the at least one one-to-one instant messaging session and/or the at least one conference instant messaging session and/or the at least one chat room session.

22. A computing device configured to implement a user interface for multiple simultaneous one-to-one instant messaging sessions, conference instant messaging sessions and chat room sessions, the computing device comprising:
a processor;
memory in electronic communication with the processor; and
instructions stored in the memory, the instructions being executable to implement a method comprising:
displaying a single user interface window having one or more of a list area, a messages area, and a message creation area;
displaying in the list area information about at least one one-to-one instant messaging session and/or at least one conference instant messaging session and/or at least one chat room session in which a user is participating;
displaying in the messages area messages corresponding to the at least one one-to-one instant messaging session and/or the at least one conference instant messaging session and/or the at least one chat room session; and
displaying in the message creation area a new message to be sent from the user to one or more other participants of the at least one one-to-one instant messaging session and/or the at least one conference instant messaging session and/or the at least one chat room session.
